(19) United States
(12) Patent Application Publication
(10) Pub. No.: US 2017/0031022 A1
(43) Pub. Date: Feb. 2, 2017

(54) Forward Scanning Sonar System and Method with Angled Fan Beams

(71) Applicant: Olexandr IVANOV, Hammonds Plains (CA)

(72) Inventor: Olexandr IVANOV, Hammonds Plains (CA)

(21) Appl. No.: 15/070,535

(22) Filed: Mar. 15, 2016

(30) Foreign Application Priority Data
Jul. 29, 2015 (CA) 2899119

(51) Int. Cl. G01S 15/89; G01S 7/62; G10K 11/00; G01S 15/87

(52) U.S. Cl. CPC G01S 15/8902; G01S 15/87; G01S 7/62; G10K 11/006

(57) ABSTRACT

A forward scanning sonar system including at least a sonar transducer and a support structure having the at least a sonar transducer mounted thereto, the at least a sonar transducer being configured such that, while during scanning operation the sonar transducer is moved along a forward moving direction, a fan-shaped beam of the sonar transducer is forming a plane oriented forwardly downwardly such that the fan-shaped beam forms a scan line oriented at a scan angle to the forward moving direction with the scan angle being greater than 0 and smaller than π/2 and such that the scan line intersects the forward direction at a point ahead of the sonar transducer.

This application claims priority to Canadian Patent Application No. 2,899,119, filed on Jul. 29, 2015, entitled FORWARD SCANNING SONAR SYSTEM AND METHOD WITH ANGLED FAN BEAMS, the entire contents of which are hereby incorporated by reference.

### FIELD

The present disclosure relates to underwater sonar systems, and more particularly, to a forward scanning sonar systems and method with angled fan beams.

### BACKGROUND

Detailed, gap-free forward sonar imaging along the path of a vessel is highly desirable in numerous applications such as, for example, navigation, obstacle avoidance, surveying, search and rescue operation, and treasure hunting.

Unfortunately, while there are various sonar systems available for sector scanning in a forward direction such as, for example, multi-beam, short aperture bathymetric, electronically or mechanically steered sonar systems, or combinations thereof, none of these sonar systems produce a frontal scanning view of the mapped area, nor can they accommodate large aperture, high resolution transducers. All these sonar systems produce a sectoral field of view where lateral selectivity is rapidly diminishing with the range. While some sonar systems such as, for example, multi-beam altimeters, are capable of producing 3-D mapped area in the forward direction, they lack detailed resolution and come at significant cost due to a large number of channels needed in the system.

On the other hand, existing side scan sonar systems, while being of high resolution and widely available, cannot be utilized for forward mapping due to the loss of selectivity in the forward direction, and are not capable of simultaneous depth profiling. Furthermore, its port and starboard imaging data suffer wide data voids at nadir direction, leaving the resulting image dissected in the middle. Attempts to mitigate this problem with supplementary nadir gap filler sonars lack resolution and come at added cost.

It may be desirable to provide a sonar system and method that enable use of high resolution sonar transducers for forward mapping.

It also may be desirable to provide a forward scanning sonar system and method that provide gap-free mapping.

It also may be desirable to provide a forward scanning sonar system and method that are simple and cost effective to implement.

It also may be desirable to provide a forward scanning sonar system and method that enable depth profiling along the path ahead.

### SUMMARY

Accordingly, in one embodiment the present invention provides a forward scanning sonar system and method that enable use of high resolution sonar transducers for forward mapping.

In one embodiment the present invention provides a forward scanning sonar system and method that provide gap-free forward mapping.

In one embodiment the present invention provides a forward scanning sonar system and method that are simple and cost effective to implement.

In one embodiment the present invention provides a forward scanning sonar system and method that enable depth profiling along the path ahead.

According to one aspect of the present invention, there is provided a forward scanning sonar system. The forward scanning sonar system includes at least an elongated sonar transducer, wet side electronics, top side computer processor, data and telemetry uplink/downlink, advanced visualization software, and a support structure having the at least a sonar transducer mounted thereto. The at least a sonar transducer is configured such that, while during scanning operation the sonar transducer is moved along a forward moving direction, a fan-shaped beam of the sonar transducer is forming a plane oriented forwardly downwardly such that the fan-shaped beam forms a scan line oriented at a scan angle to the forward moving direction with the scan angle being greater than 0 and smaller than π/2 such that scan line intersects the forward direction at a point ahead of the transducer.

According to one aspect of the present invention, there is provided a forward scanning sonar system. The forward scanning sonar system comprises a port sonar transducer and a starboard sonar transducer mounted to a support structure in an angled forward, descending triangle formation. The sonar transducers are configured such that, while during scanning operation the sonar transducers are moved along a forward moving direction, fan-shaped beams of the sonar transducers are forming planes oriented forwardly downwardly such that each of the fan-shaped beams forms a scan line oriented at a scan angle to the forward moving direction with the scan angle being greater than 0 and smaller than π/2, and such that an intersecting point of the scan lines with each other is ahead of the sonar transducers towards the forward moving direction. The port sonar transducer and the starboard sonar transducer each comprise a transmit/receive sonar transducer element for transmitting and receiving sonar pulses of the fan-shaped beam in a plane oriented substantially perpendicular to a longitudinal extension thereof. The port sonar transducer is mounted to the support structure such that the longitudinal extension is oriented rearwardly downwardly and is oriented towards port at a port angle to the vertical plane containing the forward moving direction with the port angle being greater than 0 and smaller than π/2. The starboard sonar transducer is mounted to the support structure such that the longitudinal extension is oriented rearwardly downwardly and is oriented towards starboard at a starboard angle to the vertical plane containing the forward moving direction with the starboard angle being greater than 0 and smaller than π/2.

According to one aspect of the present invention, there is provided a forward scanning sonar system. The forward scanning sonar system comprises a port sonar transducer and a starboard sonar transducer mounted to a support structure in an angled forward, ascending triangle formation. The sonar transducers are configured such that, while during scanning operation the sonar transducers are moved along a forward moving direction, fan-shaped beams of the sonar transducers are forming planes oriented forwardly downwardly such that each of the fan-shaped beams forms a scan line oriented at a scan angle to the forward moving direction with the scan angle being greater than 0 and smaller than π/2, and such that an intersecting point of the scan lines with each other is ahead of the sonar transducers towards the forward moving direction. The port sonar transducer and the starboard sonar transducer each comprise a transmit/receive sonar transducer element for transmitting and receiving sonar pulses of the fan-shaped beam in a plane oriented substantially perpendicular to a longitudinal extension thereof. The port sonar transducer is mounted to the support structure such that the longitudinal extension is oriented forwardly upwardly and is oriented towards port at a port angle to the vertical plane containing the forward moving direction with the port angle being greater than 0 and smaller than π/2. The starboard sonar transducer is mounted to the support structure such that the longitudinal extension is oriented forwardly upwardly and is oriented towards starboard at a starboard angle to the vertical plane containing the forward moving direction with the starboard angle being greater than 0 and smaller than π/2.

According to one aspect of the present invention, there is provided a forward scanning sonar method. At least a sonar transducer mounted to a support structure is moved along a forward moving direction. While moving along the forward moving direction, the at least a sonar transducer transmits sonar pulses in the form of angled fan-shaped beam. The angled fan-shaped beam of the sonar transducer forms a plane oriented forwardly downwardly and at a scan angle to the forward moving direction with the scan angle being greater than 0 and smaller than π/2 and such that the scan line intersects the forward direction at a point ahead of the transducer. while moving along the forward moving direction, sonar return echo sequences from the sonar pulses are received, converted into raw sonar return data and provided to a computer processor. Using the computer processor, imaging data are determined in dependence upon the sonar return data and passed on to a computer monitor for real time visualization or playback.

According to one aspect of the present invention, there is provided a forward scanning sonar method. A port sonar transducer and a starboard sonar transducer mounted to a support structure in an angled forward, triangle formation are moved along a forward moving direction. while moving along the forward moving direction, the sonar transducers transmit sonar pulses in the form of fan-shaped beams. The fan-shaped beams of the sonar transducer form planes oriented forwardly downwardly such that each of the fan-shaped beams forms a scan line oriented at a scan angle to the forward moving direction with the scan angle being greater than 0 and smaller than π/2, and such that an intersecting point of the scan lines with each other is ahead of the sonar transducers towards the forward moving direction. while moving along the forward moving direction, the port sonar transducer receives port sonar return echo sequences and the starboard sonar transducer receives starboard sonar return echo sequences, and both transducers receive port and starboard sonar return echo sequences along the intersect line of the two sonar beams. The port sonar return echo sequences and the starboard sonar return echo sequences are converted into raw digital port sonar return data and starboard sonar return data, respectively, and provided to a processor. Using the processor, first imaging data are determined in dependence upon the port sonar return data and second imaging data are determined in dependence upon the starboard sonar return data, and the profile data is determined upon sonar return data along the intersect line of the two sonar beams. The first imaging data and the second imaging data are then combined and displayed on a computer monitor along with the profile data in the forward direction.

According to another aspect of the present invention, there is provided a rearward scanning sonar method. At least a sonar transducer mounted to a support structure is moved along a forward moving direction. While moving along the forward moving direction, the at least a sonar transducer transmits sonar pulses in the form of angled fan-shaped beam. The angled fan-shaped beam of the sonar transducer forms a plane oriented rearwardly downwardly and at a scan angle to the forward moving direction with the scan angle being greater than 0 and smaller than π/2 and such that the scan line intersects the forward direction at a point behind the transducer. While moving along the forward moving direction, sonar return echo sequences from the sonar pulses are received, converted into raw sonar return data and provided to a computer processor. Using the computer processor, imaging data are determined in dependence upon the sonar return data and passed on to a computer monitor for real time visualization or playback.

One advantage of the present invention is that it provides a forward scanning sonar system and method that enable use of high resolution sonar transducers for forward mapping.

A further advantage of the present invention is that it provides a forward scanning sonar system and method that provide gap-free forward mapping.

A further advantage of the present invention is that it provides a forward scanning sonar system and method that simple and cost effective to implement.

A further advantage of the present invention is that it provides a forward scanning sonar system and method that enable depth profiling along the path ahead.

### BRIEF DESCRIPTION OF THE DRAWINGS

An embodiment of the present invention is described below with reference to the accompanying drawings, in which:

FIGS. 1a and 1b are simplified block diagrams illustrating in top perspective views the forward scanning process using the forward scanning sonar system according to one embodiment of the invention;

FIG. 1c is a simplified block diagram illustrating in a top view of the scanning process using the forward scanning sonar system according to one embodiment of the invention;

FIG. 1d is a simplified block diagram illustrating imaging results of the scanning process using the forward scanning sonar system and method according to one embodiment of the invention;

FIG. 1e is a simplified block diagram illustrating in a top view the scanning process for employing advanced graphics processes using the forward scanning sonar system according to one embodiment of the invention;

FIG. 2a is a simplified block diagram illustrating sonar transducer having fan-shaped directional beam employed in the forward scanning sonar system according to one embodiment of the invention, all near-field effects in the directivity ignored;

FIGS. 2b and 2c are simplified block diagrams illustrating in a perspective view a first and a second arrangement, respectively, of the sonar transducers employed in the forward scanning sonar system according to one embodiment of the invention; and,

FIGS. 3a to 3d are simplified block diagrams illustrating implementations of the forward scanning sonar system according to one embodiment of the invention having the sonar transducers mounted to a submersible glider, a towfish, a submarine, and a surface vessel, respectively.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

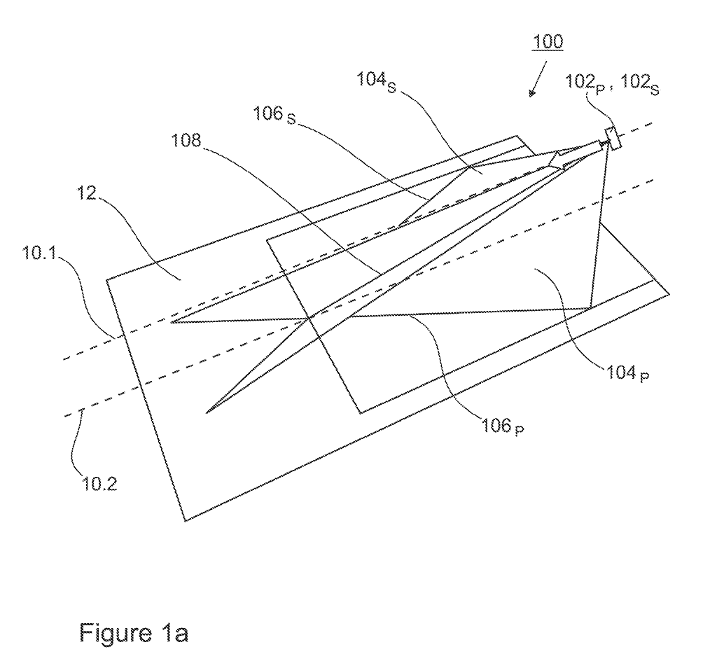

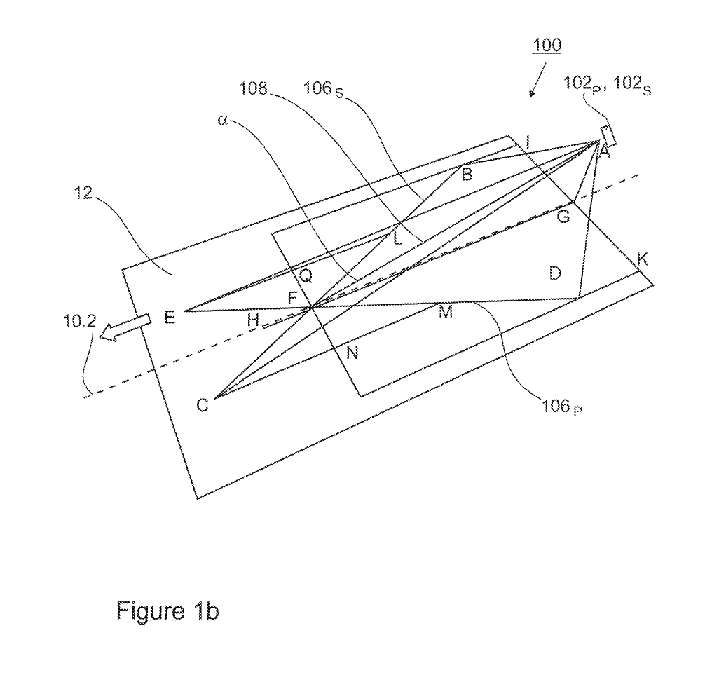

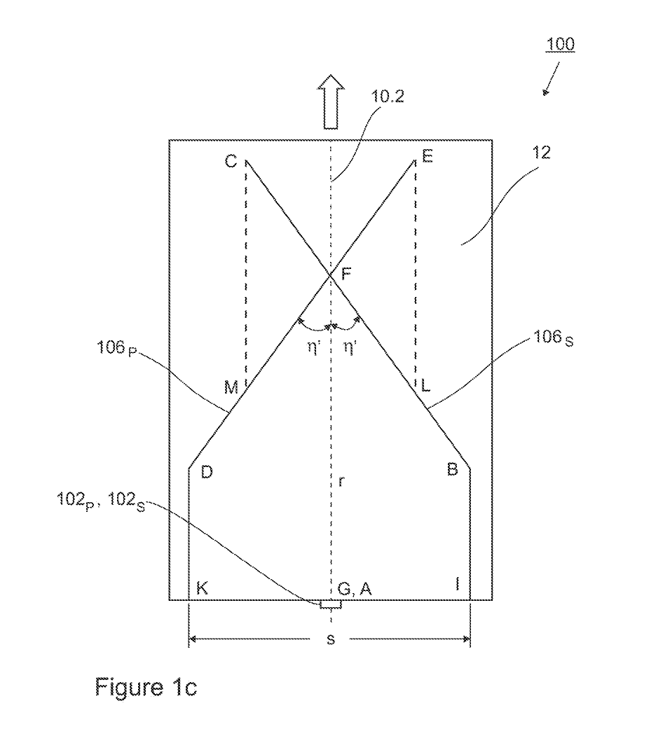

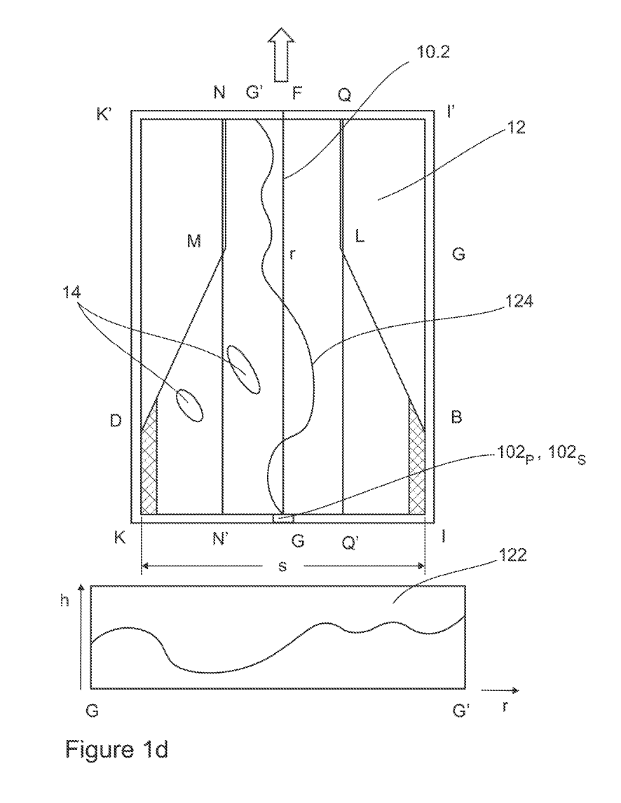

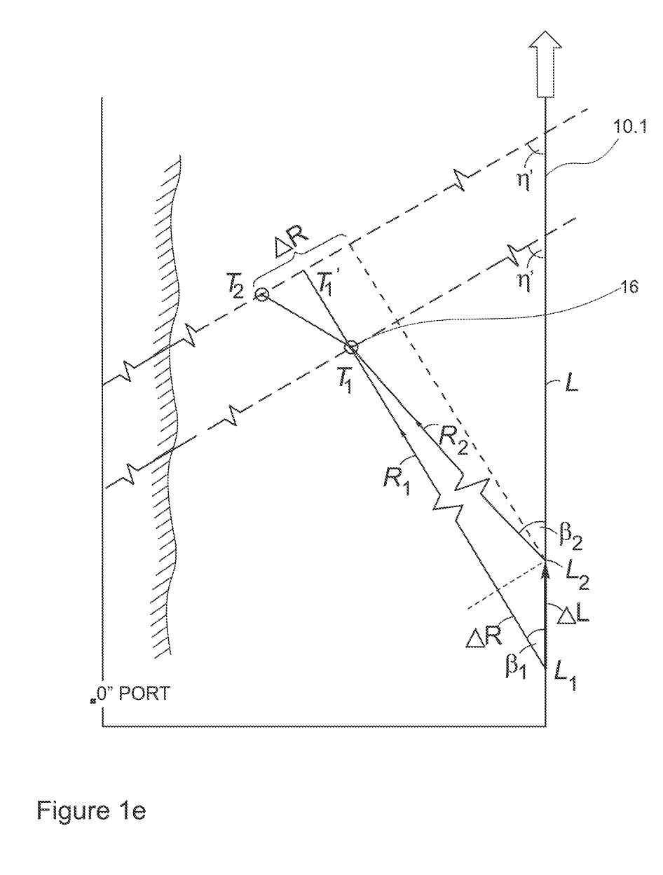

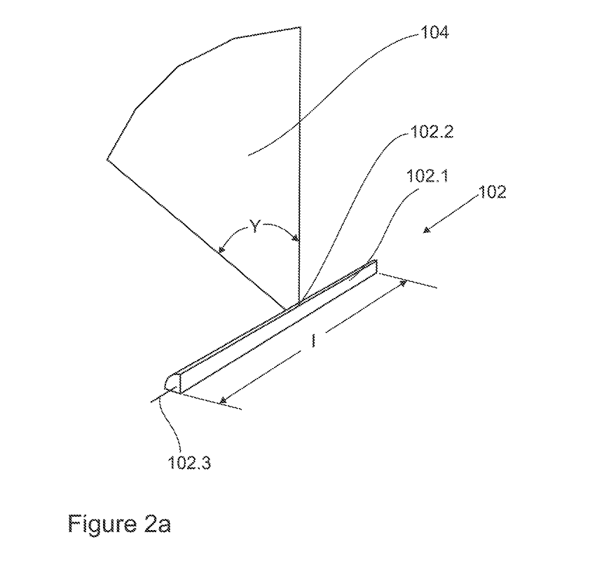

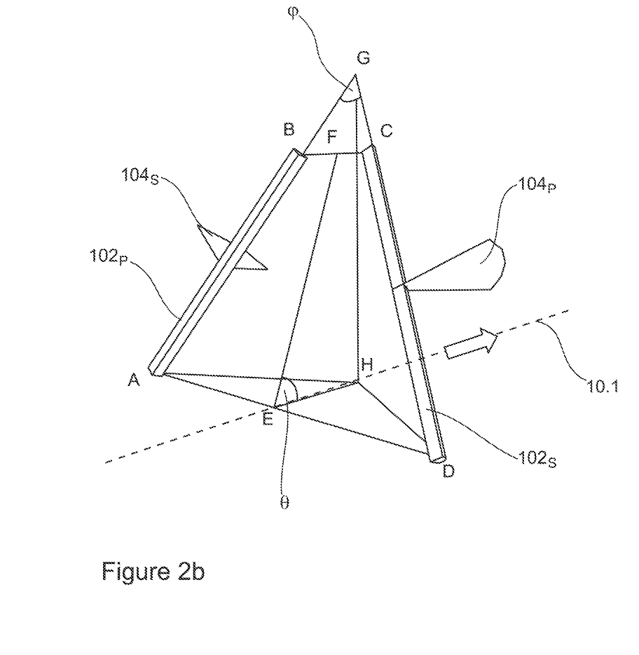

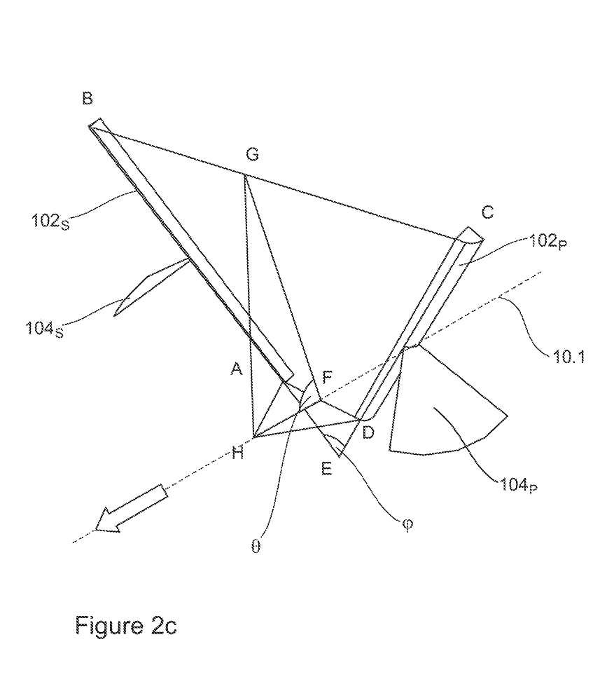

While the description of certain embodiments hereinbelow is with reference to a forward scanning sonar system and a forward scanning sonar method for simplicity, it will become evident to those skilled in the art that the embodiments of the invention are not limited thereto, but are also adaptable for implementing a rearward scanning sonar system and a rearward scanning sonar method by reversing the movement of the sonar transducers in the direction opposite to the forward moving direction indicated by the block arrow in FIGS. 1a to 1d, 2b, and 2c. Furthermore, the disclosed embodiments may also be employed for side scan applications.

Referring to FIGS. 1a to 1d, a forward scanning sonar system 100 and a forward scanning sonar method according to an embodiment of the invention are provided. The forward scanning sonar system 100 can comprise a port sonar transducer 102_{P} and a starboard sonar transducer 102_{S} mounted to a support structure such as, for example, a submersible glider, using standard underwater technologies known to one skilled in the art. The sonar transducers 102_{P}, 102_{S} and the support structure are configured such that longitudinal extensions of the sonar transducers 102_{P}, 102_{S} form an angled forward triangle. While during scanning operation the sonar transducers 102_{P},102_{S} are moved along a forward moving direction 10.1—indicated by the block arrow in FIGS. 1a to 1c, fan-shaped beams 104_{P}, 104_{S} transmitted from the sonar transducers 102_{P}, 102_{S} are forming two planes oriented forwardly downwardly such that the fan-shaped beams 104_{P}, 104_{S} form scan lines 106_{P}, 106_{S} oriented at a scan angle η′ to a vertical projection 10.2 of the forward moving direction 10.1 onto the sea floor 12 with the scan angle η′ being greater than 0 and smaller than π/2. The fan-shaped beams 104_{P}, 104_{S} intersect each other along intersecting line 108—which is angled at angle α to the forward moving direction 10.1 or its vertical projection 10.2, crosses the sea bottom floor at intersecting point F of the scan lines 106_{P}, 106_{S}—such that the intersecting point F of the scan lines 106_{P}, 106_{S} is ahead of the sonar transducers 102_{P},102_{S} in the forward moving direction 10.1, 10.2.

As illustrated in FIG. 1b, the sonar transducers 102_{P}, 102_{S} are located at point A which is at distance h—between points A and G—above the sea floor 12. The distance r—between points F and G—is the forward horizontal range to the intersecting point F. The distance s—between points I and K—is combined lateral swath provided by the transducers 102_{P}, 102_{S}. Angle α—between lines FA and FG—is the altitude of the transducers 102_{P}, 102_{S} as seen from the focal point F; it is noted that angle α is a function of angles φ and θ, α=f(φ, θ). It is also noted that range r is proportionate to h and inversely proportionate to α as r=h/tan(α), with smaller α yielding longer range r at given depth. It is also noted that parameters r and s are in an inverse relationship: a longer r leads to a shorter s, and vice versa, whereas the mapped area r*s is defined by the signal-to-noise ratio (SNR). The area defined by the points I, K, B, D, L, M, Q and N is the gap-free imaged/mapped sea floor area ahead of the sonar transducers 102_{P}, 102_{S} which is displayed on a computer monitor, for example, as illustrated in FIG. 1d. The imaged/mapped gap-free sea floor area has an aspect ratio of FG/IK or r/s. It may be desired to optimize α towards higher s for side scan application, or higher r for forward scan application, and anywhere in between for a mixed, side and forward, application.

Following transmission of sonar pulses from the port 102_{P} and the starboard transducer 102_{S}, the processed sonar echo return signals are color coded based on signal strength, and provided to a computer monitor for imaging as angled “water fall traces” drawn at angles η′ to the forward direction 10.2 to form a scaled down 2-D image of the mapped area of depth r and width s resulting in an undistorted, overlapped, gap-free frontal view of the mapped area—I, K, B, D, and F—in front of the sonar transducers 102_{P},102_{S} as they are moved forward 10.2 at a constant speed, revealing structures/objects 14.

FIG. 1d schematically illustrates a snapshot of seabed image with the monitor area KK′I′I schematically displaying a forward scan imaging field KDMNQLBI. The sonar transducer 102_{P}, 102_{S} position is marked by the point G, with the sonar transducers 102_{P},102_{S} as being moved towards the point F along the forward direction 10.2. GF and KI is the swath range r and width s, respectively. Darkened areas along the lines KD and IB represent propagation delays due to depth h. Areas along the lines MN and LQ may be affected by low SNR. N′NQQ′ is the overlapped area between port and starboard.

By transmitting a sonar pulse from the one of the port and the starboard sonar transducer 102_{P}, 102_{S} and timing the receipt of the echo return on the other sonar transducer, the forward depth h_{F} is determined for the front bottom segment along the intersecting line 108 of the two angled fan-shaped beams 104_{P} and 104_{S}, h_{F}=c*t*Sin(α)/2, where c is the speed of sound, t is propagation delay. This results in anticipated depth profile along the forward path 10.2. The depth h_{F} is then displayed, for example, on a subplot 122 or as image overlay 124, as illustrated in FIG. 1d.

The geometry of the fan-shaped beams 104_{P}, 104_{S} can be transmitted from the sonar transducers 102_{P}, 102_{S} and exploited using advanced graphics processes to improve visualization and readability of the displayed sonar images.

Referring to FIG. 1e, as the sonar moves along path 10.1 and transmits two consecutive pings at points L1 and L2 in the proximity to vertical pole 16 of height ΔL positioned at point T1. Both pings hit the target 16 at two different slant ranges R1 and R2.

Referring to FIG. 1e, as the sonar moves along path 10.1 and transmits two consecutive pings at points L1 and L2 in the proximity to vertical pole 16 of height Δh positioned at point T1. Both pings hit the target 16 at two different bearings β₁ and β₂, β₂>β₁. If conditions (1), (2) hold true,

β≦π/2−η′ (1)

Δh≧ΔL*tan(α) (2)

then both pings hit the target 16 at two different slant ranges R₁ and R₂, so that R₂<R₁:

R₂=\sqrt{R₁²−2R₁ΔL cos β₁+(ΔL)²};

β₁=0: R₁−R₂=ΔL;

β₁=π/2: R₁−R₂=0.

Because of the range difference ΔR, echo returns are displayed as two separate targets at points T1 and T2 which results in a line T1-T2 with the length depending on the bearing angle β to the target. All conditions equal, the line T1-T2 of targets of the same height will be displayed the longest at bearing angle β=0 (direct forward scanning) and be zero at bearing angle β=π/2 (direct side scanning), with targets at other bearing angles β being of intermediate length. This phenomenon is exploited using the fan-shaped beams 104_{P}, 104_{S} at bearing angles β>0 and advanced graphics processes for better visualizing vertically oriented targets by displaying vertically oriented lines as lines and vertically oriented planes as planes.

Furthermore, line T1-T1′ is an extension of Range R1 and corresponds to the cast shadow from the pole 16, which may also be displayed using the advanced graphics processes to further improve visualization in combination with the use of the fan-shaped beams 104_{P}, 104_{S} at bearing angles 0<β<π/2. It is noted that cast shadows are always cast away from the sonar source.

Condition (1) sets general limitation on bearing angle during forward scanning: it shows that wider scan angle η′ leads to a narrower field of view to avoid detection ambiguity, and vice versa.

Condition (2) provides theoretical threshold criteria on target height during forward scanning with angled beams, it shows that the smaller forward looking angle a is, the smaller target height Δh can be detected. Practical value of Δh will be further limited by sonar directivity and signal-to-noise ratio as described by standard sonar equations.

FIG. 2a illustrates a state of the art sonar transducer 102 comprising an elongated and streamlined housing 102.1 having disposed therein a transmit/receive sonar transducer element 102.2. RF power and data transfer is enabled via cable 102.3. The transducer element 102.2 transmits sonar pulses forming a fan-shaped beam 104—having beam spread γ—in a plane oriented substantially perpendicular to the longitudinal extension 1 of the sonar transducer 102. In an example implementation of the forward scanning sonar system 100 high resolution side scan sonar transducers—Jetasonic® 1240 PX—having length l of 30″ and beam spread γ of 60° have been employed.

While the description of the disclosed embodiments of the forward scanning sonar system 100 is with reference to a sonar transducer 102 having only one transmit/receive sonar transducer element, it will become evident to those skilled in the art that the embodiments of the invention are not limited thereto, but may employ sonar transducers having more than one transmit/receive element operating in different frequency bands or separate transmitter and receiver elements, as long as they are placed in close proximity to each other, configured in angled triangular formation and produce fan-shaped beams as illustrated in FIGS. 2b and 2c.

FIG. 2b illustrates a first arrangement of the sonar transducers 102_{P}, 102_{S} for realizing the forward scan sonar system 100 described hereinabove using the sonar transducer 102 illustrated in FIG. 2a. The sonar transducers 102_{P}, 102_{S} are arranged forming angled forward descending triangle AGD oriented rearwardly downwardly at angle θ to the forward direction 10.1—indicated by the block arrow. Line BC represents base distance b between transducers 102_{P} and 102_{S}. The port sonar transducer 102_{P} is oriented towards port at angle φ_{P} to the vertical plane containing the forward direction 10.1, with φ_{P} being greater than 0 and smaller than π/2, and the starboard sonar transducer 102_{S} is oriented towards starboard at angle φ_{S} to the vertical plane containing the forward direction 10.1, with φ_{S} being greater than 0 and smaller than π/2. The port sonar transducer 102_{P} and the starboard sonar transducer 102_{S} can be of the same length l and oriented rearwardly downwardly at a same angle θ and the port angle and the starboard angle are a same angle φ_{P}=φ_{S}=π/2 resulting in an angled forward, descending isosceles triangle.

If distance b and transducer length l and are small compared to the forward range r, b<<r and l<<r, the position and orientation of the fan beams 104_{P}, 104_{S} is then defined by a set of three angles (φ, θ, γ), based on the geometries illustrated in FIGS. 1b and 2b. The arrangement, as illustrated in FIG. 2b, creates two converging fan beams 104_{P}, 104_{S} which are angled forwardly downwardly and intersect each other along the line 108.

FIG. 2c illustrates a second arrangement of the sonar transducers 102_{P}, 102_{S} for realizing the forward scan sonar system 100 described hereinabove using the sonar transducer 102 illustrated in FIG. 2a. The sonar transducers 102_{P}, 102_{S} are arranged forming angled forward ascending triangle ACE oriented forwardly upwardly at angle θ to the forward direction 10.1 indicated by the block arrow. The port sonar transducer 102_{P} is oriented towards port at angle φ_{P} to the vertical plane containing the forward direction 10.1, with φ_{P} being greater than 0 and smaller than π/2, and the starboard sonar transducer 102_{S} is oriented towards starboard at angle φ_{S} to the vertical plane containing the forward direction 10.1 with φ_{S} being greater than 0 and smaller than π/2. The port sonar transducer 102_{P} and the starboard sonar transducer 102_{S} can be of the same length F and oriented forwardly upwardly at a same angle θ and the port angle and the starboard angle are a same angle φ_{P}=φ_{S}=φ/2 resulting in an angled forward, ascending isosceles triangle. Line AD represents base distance b between transducers 102_{P} and 102_{S}.

If the same conditions apply, b<<r and F<<r, the position and orientation of the fan beams 104_{P}, 104_{S} is then defined by a set of three angles (φ, θ, γ), based on the geometries illustrated in FIGS. 1b and 2c. The arrangement illustrated in FIG. 2c creates two converging fan beams 104_{P}, 104_{S} which are angled forwardly downwardly and intersect along the line 108.

By varying the angles γ, φ and θ, a wide range of aspect ratios r/s is achieved. For example, for γ=φ=60° and θ=15° a mapped seabed area r*s=38*26 m2 per every 10 m of water column is achieved while α=15.8°and the scan angle η′=24.1°. It is noted that, a higher r/s ratio can provide advantages for a long range forward scan application, and a lower r/s ratio can provide advantages for a wide swath side scan sonar application.

Optionally, phased arrays may be used instead of fixed beams to vary the bearing of the beam intersect enabling multiple depth readings across the mapped field.

Further optionally, the orientation of the port and starboard sonar transducers may be different, resulting in an asymmetrical field of view.

Further optionally, more than two sonar transducers may be employed, added in pairs, for example, with each pair of sonar transducers having its own orientation φ, θ, and spread γ.

Further optionally, only one sonar transducer may be employed for imaging, creating an asymmetric field of view and at the loss of up to 50% of data. It is noted that depth profiling requires at least two intersecting beams.

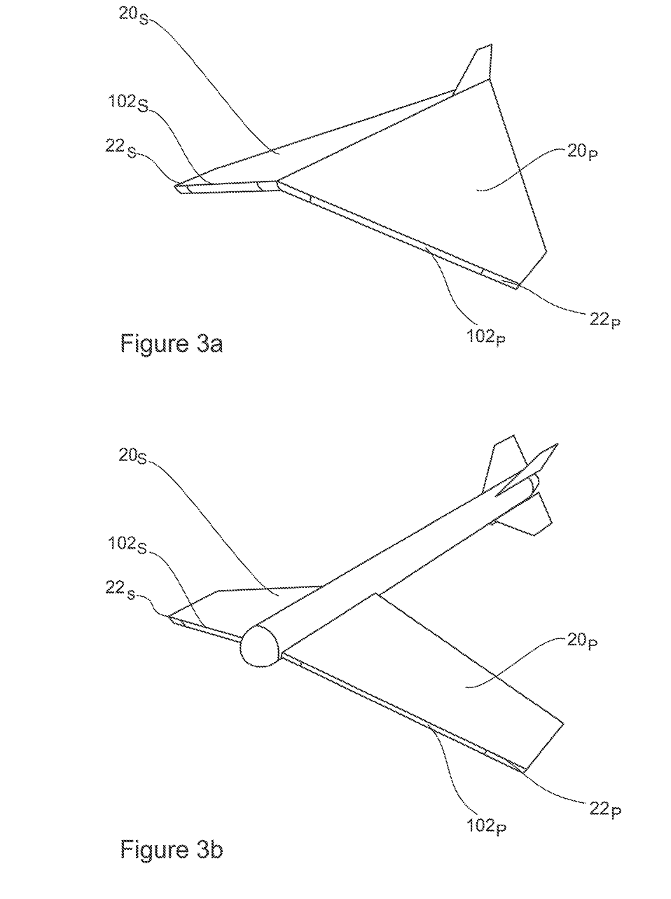

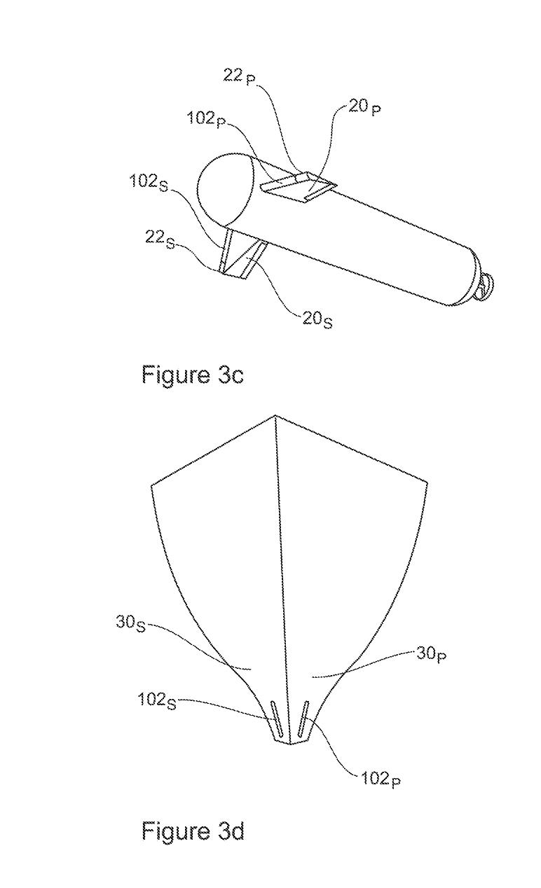

The sonar transducers 102_{P}, 102_{S} may be incorporated into respective leading edges 22_{P}, 22_{S} of wings 20_{P}, 20_{S} of various underwater vehicles such as, for example, a submersible glider, a towfish, or a submarine, as illustrated in FIGS. 3a to 3c, respectively. It is noted that in FIGS. 3a to 3c the leading edges 22_{P}, 22_{S}are oriented rearwardly downwardly allowing implementation of the arrangement illustrated in FIG. 2b.

Alternatively, the wings 20_{P}, 20_{S} are oriented upwardly enabling orientation of the leading edges 22_{P}, 22_{S} forwardly upwardly for implementing the arrangement illustrated in FIG. 2c. The sonar transducers 102_{P}, 102_{S} can have a streamlined front enabling seamless incorporation into the leading edges 22_{P}, 22_{S}.

The sonar transducers 102_{P}, 102_{S} may also be mounted to a keel or respective port and starboard hull sections 30_{P}, 30_{S} of a surface vessel, as illustrated in FIG. 3d, for example, implementing the arrangement illustrated in FIG. 2c.

It is noted, that FIGS. 3a to 3d illustrate only examples for deploying the forward scanning sonar system 100 but is not limited thereto, and that it will become evident to those skilled in the art that the embodiments of the invention are not limited thereto, but may be deployed in various other ways such as, for example using a boom mounted to various types of marine vessels.

Besides transducers, the forward scanning sonar system 100 uses standard system blocks that can be found, by way of example, in side scan sonar systems such as, among others, tuning networks, power amplifier, analog front end (AFE), A/D and D/A converters, digital signal processor (DSP), field-programmable gate array (FPGA), communication ports, top side PC computer, sensors (compass, GPS, pressure, pitch/roll), and may include various firmware and software. For use with the forward scanning sonar system, a graphic user interface (GUI) and advanced visualization software for high-resolution, gap-free imaging and forward profiling has been designed using standard computer and programming technologies known to one skilled in the art.

Signal generation and data acquisition in the forward scanning sonar system 100 is performed in a way that can be found in a side scan sonar. For example, using pulse compression port imaging data are determined in dependence upon port sonar return signals and starboard imaging data are determined in dependence upon the starboard sonar return signals and passed on to a topside PC via communication port. The port imaging data and the starboard imaging data are then combined and displayed on a computer monitor by the visualization software as a gap-free, range calibrated, imaged and profiled dataset ahead of the sonar as illustrated in FIG. 1d.

The forward imaging process is performed as follows. A port sonar transducer 102_{P} and a starboard sonar transducer 102_{S} mounted to a support structure are moved along a forward moving direction 10.1. While moving along the forward moving direction 10.1, the sonar transducers 102_{P}, 102_{S} transmit sonar pulses in the form of fan-shaped beams 104. The sonar pulses may be transmitted AM or FM modulated, or a combination thereof. The fan-shaped beams 104 of the sonar transducers form converging beam planes oriented forwardly downwardly and at a scan angle to the forward moving direction 10.1 with the scan angle being greater than 0 and smaller than π/2 and intersect each other. While moving along the forward moving direction, the port sonar transducer 102_{P} receives port sonar return signals from the port or starboard sonar pulses and the starboard sonar transducer 102_{S} receives starboard sonar return signals from the starboard or port sonar pulses, depending on user controls and transducer configuration. The port sonar return signals and the starboard sonar return signals are received, converted into port sonar return data and starboard sonar return data, respectively, or vice versa, and provided to a processor or FPGA. Using the processor, port imaging data are determined in dependence upon the port sonar return data and starboard imaging data are determined in dependence upon the starboard sonar return data. The port imaging data and the starboard imaging data are then combined and passed on to a topside computer for real time visualization, playback, and storage.

To provide a forward depth profile along the intersecting line of the two fan beams one of the port sonar transducer 102_{P} and the starboard sonar transducer 102_{S} transmits sonar pulses while moving along the forward direction 10 which are received by the other sonar transducer. By timing the transmission of the sonar pulses and the receipt of the sonar echo return pulses, depth h is determined in dependence thereupon using the processor or FPGA. The depth profiling can be performed simultaneously with the imaging process above.

Optionally, the imaging process is omitted and the forward scanning sonar system 100 is employed for depth profiling of the path ahead for obstacle avoidance, for example, for use with surface vessels and submarines.

The present invention has been described herein with regard to certain embodiments. However, it will be obvious to persons skilled in the art that a number of variations and modifications can be made without departing from the scope of the invention as described herein.

What is claimed is:

1. A forward scanning sonar system comprising:
a support structure; and,
at least a sonar transducer mounted to the support structure, the at least a sonar transducer being configured such that, while during scanning operation the sonar transducer is moved along a forward moving direction, a fan-shaped beam of the sonar transducer is forming a plane oriented forwardly downwardly such that the fan-shaped beam forms a scan line oriented at a scan angle to the forward moving direction with the scan angle being greater than 0 and smaller than π/2 and such that the scan line intersects the forward direction at a point ahead of the transducer.

2. The forward scanning sonar system according to claim 1 wherein the at least a sonar transducer comprises a port sonar transducer and a starboard sonar transducer configured such that a port fan-shaped beam of the port sonar transducer intersects a starboard fan-shaped beam of the starboard sonar transducer in the forward direction.

3. The forward scanning sonar system according to claim 2 wherein the port sonar transducer and the starboard sonar transducer are configured such that an intersecting point of the scan line of the port fan-shaped beam and the scan line of the starboard fan-shaped beam is ahead of the sonar transducer in the forward direction.

4. The forward scanning sonar system according to claim 3 wherein the port sonar transducer and the starboard sonar transducer are configured such that the port fan-shaped beam and the starboard fan-shaped beam are angled forwardly downwardly at a same downward angle and such that the scan lines of the port fan-shaped beam and the starboard fan-shaped beam are oriented in opposite direction at a same scan angle to the forward moving direction.

5. The forward scanning sonar system according to claim 4 wherein the port sonar transducer and the starboard sonar transducer each comprise a transmit/receive sonar transducer element for transmitting sonar pulses of the fan-shaped beam in a plane oriented substantially perpendicular to a longitudinal extension thereof, and wherein the port sonar transducer is mounted to the support structure such that the longitudinal extension is oriented rearwardly downwardly and is oriented towards port at a port angle to the vertical plane comprising the forward moving direction with the port angle being greater than 0 and smaller than π/2, and wherein the starboard sonar transducer is mounted to the support structure such that the longitudinal extension is oriented rearwardly downwardly and is oriented towards starboard at a starboard angle to the vertical plane comprising the forward moving direction with the starboard angle being greater than 0 and smaller than π/2.

6. The forward scanning sonar system according to claim 5 wherein the longitudinal extensions of the port sonar transducer and the starboard sonar transducer are oriented rearwardly downwardly at a same downward angle, and wherein the port angle and the starboard angle are a same angle.

7. The forward scanning sonar system according to claim 4 wherein the port sonar transducer and the starboard sonar transducer each comprise a transmit/receive sonar transducer element for transmitting sonar pulses of the fan-shaped beam in a plane oriented substantially perpendicular to a longitudinal extension thereof, and wherein the port sonar transducer is mounted to the support structure such that the longitudinal extension is oriented forwardly upwardly and is oriented towards port at a port angle to the vertical plane comprising the forward moving direction with the port angle being greater than 0 and smaller than π/2, and wherein the starboard sonar transducer is mounted to the support structure such that the longitudinal extension is oriented forwardly upwardly and is oriented towards starboard at a starboard angle to the vertical plane comprising the forward moving direction with the starboard angle being greater than 0 and smaller than π/2.

8. The forward scanning sonar system according to claim 7 wherein the longitudinal extensions of the port sonar transducer and the starboard sonar transducer are oriented forwardly upwardly at a same upward angle, and wherein the port angle and the starboard angle are a same angle.

9. A forward scanning sonar method comprising:
a) providing at least a sonar transducer;
b) providing a support structure having the at least a sonar transducer mounted thereto;
c) moving the support structure and the at least a sonar transducer along a forward moving direction;
d) while moving along the forward moving direction, the at least a sonar transducer transmitting sonar pulses in the form of a fan-shaped beam, wherein the a fan-shaped beam of the sonar transducer is forming a plane oriented forwardly downwardly such that the fan-shaped beam forms a scan line oriented at a scan angle to the forward moving direction with the scan angle being greater than 0 and smaller than π/2 and such that the scan line intersects the forward direction at a point ahead of the transducer;
e) while moving along the forward moving direction, receiving sonar echo sequences from the sonar pulses and converting the same into raw sonar return data;
f) providing the raw sonar return data to a processor;
g) using the processor, determining imaging data in dependence upon the raw sonar return data; and, h) displaying the imaging data on a monitor.

10. The forward scanning sonar method according to claim 9 wherein a port sonar transducer and a starboard sonar transducer are provided such a port fan-shaped beam of the port sonar transducer intersects a starboard fan-shaped beam of the starboard sonar transducer and such that an intersecting focal point of the scan line of the port fan-shaped beam and the scan line of the starboard fan-shaped beam is ahead of the sonar transducer in the forward moving direction.

11. The forward scanning sonar method according to claim 10 wherein e) comprises: the port sonar transducer receiving port or starboard sonar echo sequences and the starboard sonar transducer receiving starboard or port sonar echo sequences; and, converting the port sonar return signals into port raw sonar return data and the starboard sonar return signals into starboard raw sonar return data.

12. The forward scanning sonar method according to claim 11 wherein g) comprises determining first imaging data in dependence upon the port raw sonar return data and second imaging data in dependence upon the starboard raw sonar return data

13. The forward scanning sonar method according to claim 12 wherein g) comprises combining the first imaging data and the second imaging data.

14. The forward scanning sonar method according to claim 10 wherein f) to h) are performed while moving along the forward moving direction.

15. The forward scanning sonar method according to claim 9 wherein e) to g) are performed by the processor executing a standard acquisition process for processing raw side scan sonar return data.

16. The forward scanning sonar method according to claim 13 wherein h) comprises generating a gap-free image for display based on the combined first and second imaging data, wherein the combined imaging data are displayed as angled water fall traces drawn at the scan angles to the forward direction to form a 2-D image.

17. The forward scanning sonar method according to claim 10 comprising:
i) one of the port or starboard sonar transducers transmitting a sonar pulse;
j) the second sonar transducer receiving sonar return echo sequence along the beam intersecting line and converting the same into sonar return data; and,
k) timing the transmission of the sonar pulse by one transducer and the receipt of the return echo by another transducer and determining anticipated forward depth in dependence thereupon.

18. The forward scanning sonar method according to claim 17 wherein i) to k) are performed while moving along the forward moving direction.

19. The forward scanning sonar method according to claim 9 wherein in g) an advanced graphics process is employed for processing at least two echo return signals from a same object, and wherein in h) vertically oriented lines are displayed as lines and vertically oriented planes are displayed as planes.

20. A rearward scanning sonar method comprising:
a) providing at least a sonar transducer;
b) providing a support structure having the at least a sonar transducer mounted thereto;
c) moving the support structure and the at least a sonar transducer along a forward moving direction;
d) while moving along the forward moving direction, the at least a sonar transducer transmitting sonar pulses in the form of a fan-shaped beam, wherein the a fan-shaped beam of the sonar transducer is forming a plane oriented rearwardly downwardly such that the fan-shaped beam forms a scan line oriented at a scan angle to the forward moving direction with the scan angle being greater than 0 and smaller than π/2 and such that the scan line intersects the forward direction at a point behind the transducer;
e) while moving along the forward moving direction, receiving sonar echo sequences from the
sonar pulses and converting the same into raw sonar return data;
f) providing the raw sonar return data to a processor;
g) using the processor, determining imaging data in dependence upon the raw sonar return data; and,
h) displaying the imaging data on a monitor.
